(19) United States
(12) Patent Application Publication
(10) Pub. No.: US 2014/0151081 A1
(43) Pub. Date: Jun. 5, 2014

(54) ELECTRIC JUNCTION BOX

(71) Applicant: YAZAKI CORPORATION, Tokyo (JP)

(72) Inventor: Masahiro Makino, Makinohara-shi (JP)

(73) Assignee: YAZAKI CORPORATION, Tokyo (JP)

(21) Appl. No.: 14/087,349

(22) Filed: Nov. 22, 2013

(30) Foreign Application Priority Data
Nov. 30, 2012 (JP) 2012-262086

(51) Int. Cl. H02G 3/08

(52) U.S. Cl. CPC H02G 3/08
USPC 174/50

(57) ABSTRACT

An electric junction box that fluid which bouncing off a vehicle body pane can be prevented from entering from the drainage hole into a case is provided. A case of the electric junction box includes a frame attached to parts and a lower cover attached to a lower end portion of the frame. The lower cover includes a positioning boss which is inserted in a positioning hole disposed in the vehicle body panel. The positioning boss extends from a lower end portion of a bottom wall of the lower cover. Also, a communication hole, which opens on a tip of the positioning boss, passes through the positioning boss and communicates with both an exterior of the vehicle body panel and an interior of the case, wherein fluid is drained out of the case through the communication hole.

### CROSS-REFERENCE TO RELATED APPLICATIONS

The present invention is based on Japanese Patent Application No. 2012-262086, which is incorporated herein by reference.

### BACKGROUND OF THE INVENTION

1. Field of the Invention

The invention relates to an electric junction box which is suitable for being incorporated in a vehicle.

2. Background of the Invention

Although an electric junction box incorporated in a vehicle has several structures such as an electric junction box shown in FIG. 2, a structure that a drainage hole 331 is provided at a lower end portion of a case 310 is generally known. See Japanese Unexamined Patent Publication No. 2006-320133.

The case 301 includes a frame 302 to which several parts are attached and a lower cover 303 attached to a lower end portion of the frame 302. The lower cover 303 includes the drainage hole 331, a bracket 305 fixed to a vehicle body panel 306 by a bolt 307 (A sign 306b in FIG. 2 is an insertion hole through which the bolt 307 is passed), and a positioning boss 304, which is inserted into a positioning hole 306a formed in the vehicle body panel 306.

When the electric junction box 310 is mounted to the vehicle, that is, when the bracket 305 is fixed to the vehicle body panel 306 by the bolt, the positioning boss 304 is configured to position and temporarily fix the electric junction box 310.

In this electric junction box 310, fluid (e.g. water) penetrating into the case 301 flows to a lower end portion of the case 301 and is drained out of the case 301 through a drainage hole 331. This drainage pathway is indicated by an arrow “M” in FIG. 2.

However, in the aforementioned electric junction box 310, there is a drawback that fluid bouncing off the vehicle body panel 306 enters from the drainage hole 331 into the case 1, as indicated by an arrow “N” in FIG. 2.

### SUMMARY OF THE INVENTION

In view of the above drawback, this invention has the purpose to provide the electric junction box in which fluid bouncing off the vehicle body panel can be prevented from entering from the drainage hole into a case.

To achieve above purpose, as one aspect of the invention, there is provided an electric junction box, which includes a case having a positioning boss at the lower end portion of the case. The positioning boss is inserted in a positioning hole disposed in a vehicle body panel. A communication hole is formed inside the positioning boss, passing through the positioning boss, and communicates with an interior of the case and an exterior of the vehicle body panel. In the above configuration, fluid can be drained out of the case through the communication hole.

### BRIEF DESCRIPTION OF THE DRAWINGS

FIG. 1 is a cross sectional view indicating an electric junction box in accordance with an exemplary embodiment of the invention.

FIG. 2 is a cross sectional view indicating a conventional electric junction box.

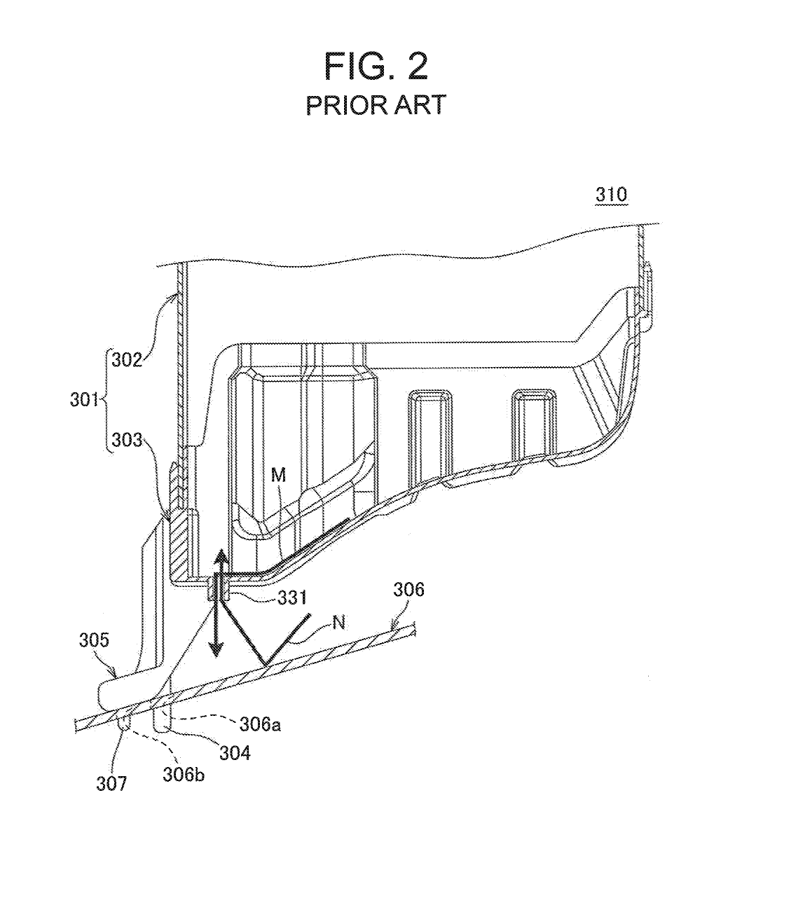

### DESCRIPTION OF THE EMBODIMENTS

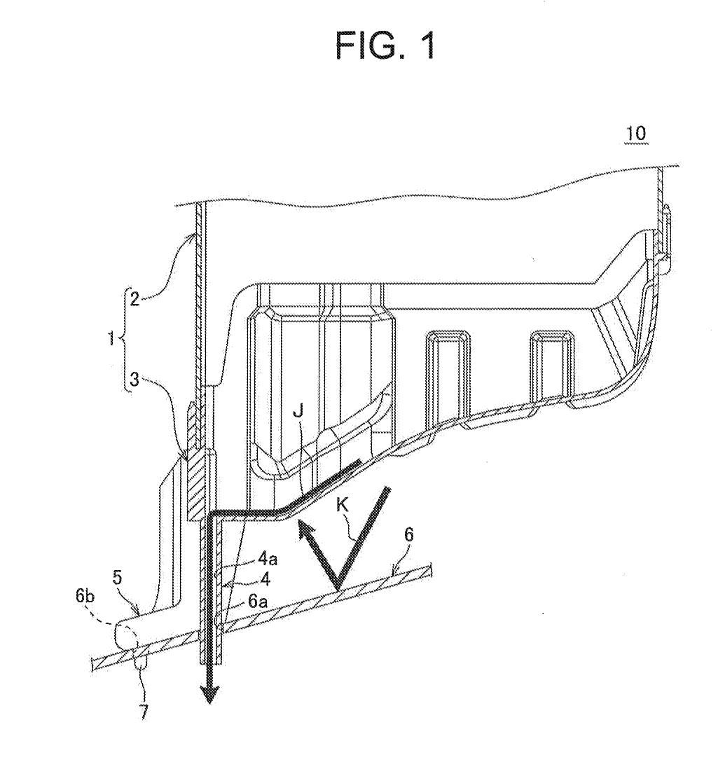

An electric junction box related to an embodiment of this invention is described by referring to FIG. 1. The electric junction box of this invention is mounted to a vehicle, and capable of power supply and signal transmission for electronic apparatus installed in the vehicle.

An electric junction box shown in FIG. 1 provides a case 1, which includes a frame 2 to which several parts are attached and a lower cover 3 attached to a lower end portion of the frame 2. The frame 2 and the lower cover 3 are formed of synthetic resin.

The aforementioned lower cover 3 includes a bracket 5 fixed a vehicle body panel 6 by a bolt 7 and a positioning boss 4 inserted into a positioning hole 6a of the vehicle body panel 6. When the electric junction box 10 is mounted to a vehicle, that is, when the bracket 5 is fixed. to the vehicle body panel 6 by a bolt, the positioning boss 4 is configured to position and temporarily fix the electric junction box 10.

The aforementioned positioning boss 4, in this embodiment, is integrally provided with the bracket 5. The positioning boss 4 extends towards the vehicle body panel 6 beyond a vehicle body panel-abutting surface of the bracket 5.

The case 1 is further provided with a communication hole 4a, which opens on a tip of the positioning boss 4, and communicates with an interior of the case. In other words, the communication hole 4a is disposed inside the positioning boss 4 and thus communicates with the interior of the case 1 and the exterior of the vehicle body panel 6.

In this electric junction box 10, fluid such as water penetrating into the case 1 flows to the lower end portion of the bottom wall of the lower cover 3 and is drained out of the case 1 through the communication hole 4a. This drainage pathway is indicated by an arrow “J” in FIG. 1. Thus the positioning boss 4 functions as a drainage hole in the electric junction box 10, thereby allowing the case to be downsized. As shown in FIG. 1 the tip of the positioning boss 4 is inserted in the positioning hole 6a of the vehicle body panel 6. As a result, fluid bouncing off the vehicle body panel 6 as indicated by an arrow “K” is prevented from entering from the communication hole 4a (i.e., the drainage hole) into the case 1.

While, in the aforementioned embodiment the frame 2 and the lower cover 3 are separately or independently formed, the frame 2 may be integrally formed with the lower cover 3.

Furthermore, the aforementioned embodiments are only shown some representatives of this invention, and this invention is not limited of these embodiments. Therefore, it can be performed with several changes without deviating from the scope of this invention.

### REFERENCE SIGNS LIST

1 case

2 frame

3 lower cover

4 positioning boss

4a communication hole

6 vehicle body panel

6a positioning hole

10 electric junction box

What is claimed is:

1. An electric junction box, comprising:
a case having a positioning boss at a lower end portion thereof, the positioning boss being inserted in a positioning hole disposed in a vehicle body panel, and
a communication hole passing through the positioning boss and communicating with both an exterior of the vehicle body panel and an interior of the case, wherein fluid is drained out of the case through the communication hole.
